(19) United States
(12) Patent Application Publication
(10) Pub. No.: US 2021/0065032 A1
(43) Pub. Date: Mar. 4, 2021

(54) GENERALIZED LINEAR MIXED MODEL WITH DESTINATION PERSONALIZATION

(71) Applicant: Microsoft Technology Licensing, LLC, Redmond, WA (US)

(72) Inventors: Samaneh Abbasi Moghaddam, Santa Clara, CA (US); Aastha Jain, Sunnyvale, CA (US)

(21) Appl. No.: 16/556,110

(22) Filed: Aug. 29, 2019

(51) Int. Cl. G06N 7/00; H04L 12/58

(52) U.S. Cl. CPC G06N 7/005; H04L 51/32

(57) ABSTRACT

Techniques for generating recommendations using a generalized linear mixed model with destination user personalization are disclosed herein. In some embodiments, a computer system generates corresponding scores for destination user candidates based on a generalized linear mixed model comprising a global model and a destination user model. The global model is a generalized linear model based on feature data of a source user and feature data of the destination user candidates, and the destination user model is a random effects model based on behavior data of the destination user candidates indicating whether the destination user candidates performed a destination user action in response to a source user action performed by reference source users similar to the source user. The computer system selects a subset of the destination user candidates for recommendation to the source user based on the scores of the subset of the destination user candidates.

### TECHNICAL FIELD

The present application relates generally to systems and methods, and computer program products for generating recommendations using a generalized linear mixed model with destination user personalization.

### BACKGROUND

Networked services often recommend to users, referred to herein as source users, that they perform an online action, referred to herein as a source user action, directed towards other users, referred to herein as destination users, where the source user action is configured to prompt the destination users to perform another action, referred to herein as a destination action. For example, a networked service may recommend to a user, a source user, that he or she invite another user, a destination user, to connect with him or her via the networked service. However, the models used to generate these recommendations lack user-level personalization. As a result, many of the recommendations presented to the source user are not relevant to the source user, resulting in a lack of engagement by the source user with the recommendations, such as not performing the source user action. Furthermore, even in situations in which the source user finds a recommendation directed to a particular destination user to be relevant and performs the recommended online action directed towards the destination user, the destination user sometimes does not find the prompting to perform the corresponding destination action to be relevant to him or her, resulting in a lack of engagement by the destination user, such as not performing the destination user action.

Irrelevant recommendations result in technical problems for the computer systems of networked services, as well as for the client devices interacting with the networked services. Users are often forced to navigate through irrelevant recommendations to find the recommendations that are relevant to him or her. Additionally, displaying irrelevant recommendations to a user before recommendations that are relevant to the user is a waste of real estate on the screen of the computing device on which the recommendations are displayed, which is especially troublesome for use cases involving a smartphone or other mobile device with a small screen size. As another example, displaying irrelevant recommendations to a user leads to undesirable consumption of electronic resources, such as bandwidth, power of the computing device on which the recommendations are displayed, and processor workload of the computing device on which the recommendations are displayed. As a result, the functioning of the computing device is negatively affected. Other technical problems may arise as well.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a client-server system, in accordance with an example embodiment.

FIG. 2 is a block diagram showing the functional components of a social networking service within a networked system, in accordance with an example embodiment.

FIG. 3 is a block diagram illustrating components of a recommendation system, in accordance with an example embodiment.

FIG. 4 illustrates a graphical user interface (GUI) in which recommendations for performing a particular source user action directed towards destination users are displayed to a source user, in accordance with an example embodiment.

FIG. 5 illustrates a GUI in which a selectable option to perform a particular destination user action is displayed to a destination user as a result of the source user performing the particular source user action, in accordance with an example embodiment.

FIG. 6 illustrates a table of behavior data for source users and for destination users, in accordance with an example embodiment.

FIG. 7 is a flowchart illustrating a method of generating recommendations using a generalized linear mixed model with destination user personalization, in accordance with an example embodiment.

FIG. 8 is a block diagram illustrating a mobile device, in accordance with some example embodiments.

FIG. 9 is a block diagram of an example computer system on which methodologies described herein may be executed, in accordance with an example embodiment.

### DETAILED DESCRIPTION

### I. Overview

Example methods and systems of generating recommendations using a generalized linear mixed model with destination user personalization are disclosed. In the following description, for purposes of explanation, numerous specific details are set forth in order to provide a thorough understanding of example embodiments. It will be evident, however, to one skilled in the art that the present embodiments may be practiced without these specific details.

Some or all of the above problems may be addressed by one or more example embodiments disclosed herein. The implementation of the features disclosed herein involves a non-generic, unconventional, and non-routine operation or combination of operations. In some example embodiments, a specially-configured computer system generates recommendations of destination users for which a source user should perform a source user action that is configured to prompt the destination users to perform a particular destination action. The computer system uses a generalized linear mixed model to generate scores for destination user candidates, and then selects a subset of the destination user candidates to use for the recommendations based on their corresponding scores. The generalized linear mixed model comprises a global model and a destination user model. The global model is a generalized linear model based on a comparison of the feature data of the destination user candidates with the source user. The destination user model is a random effects model based on behavior data of the destination user candidates indicating whether the destination user candidates performed a particular destination user action in response to the source user action performed by reference source users determined to have profiles with feature data similar to the feature data of the profile of the source user. The personalization of the generalized linear mixed model based on the destination user side improves the relevance and, therefore, the quality of the recommendations.

By applying one or more of the solutions disclosed herein, the computer system ensures that the communication of online content to and between users is relevant to the users, thereby resulting in such technical effects as reducing excessive consumption of electronic resources associated with a lack of personalization. As a result, the functioning of the computer system and the functioning of the client devices interacting with the computer system are improved. Other technical effects will be apparent from this disclosure as well.

### II. Detailed Example Embodiments

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

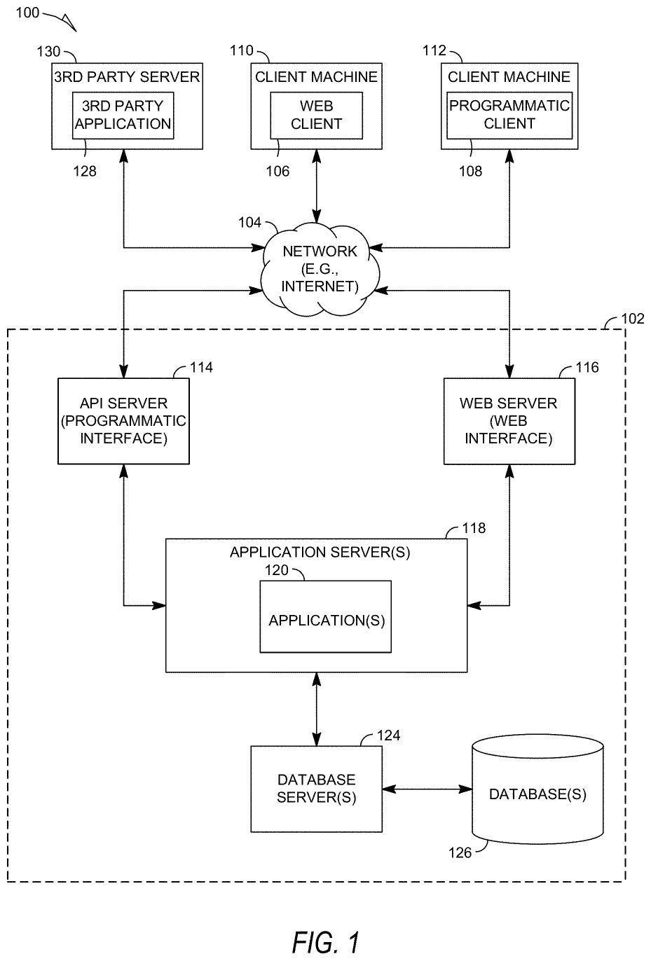

FIG. 1 is a block diagram illustrating a client-server system 100, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third-party application 128, executing on a third-party server machine 130, as having programmatic access to the networked system 102 via the programmatic interface provided by the API server 114. For example, the third-party application 128 may, utilizing information retrieved from the networked system 102, support one or more features or functions on a website hosted by the third-party. The third-party website may, for example, provide one or more functions that are supported by the relevant applications of the networked system 102.

In some embodiments, any web site referred to herein may comprise online content that may be rendered on a variety of devices, including but not limited to, a desktop personal computer, a laptop, and a mobile device (e.g., a tablet computer, smartphone, etc.). In this respect, any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

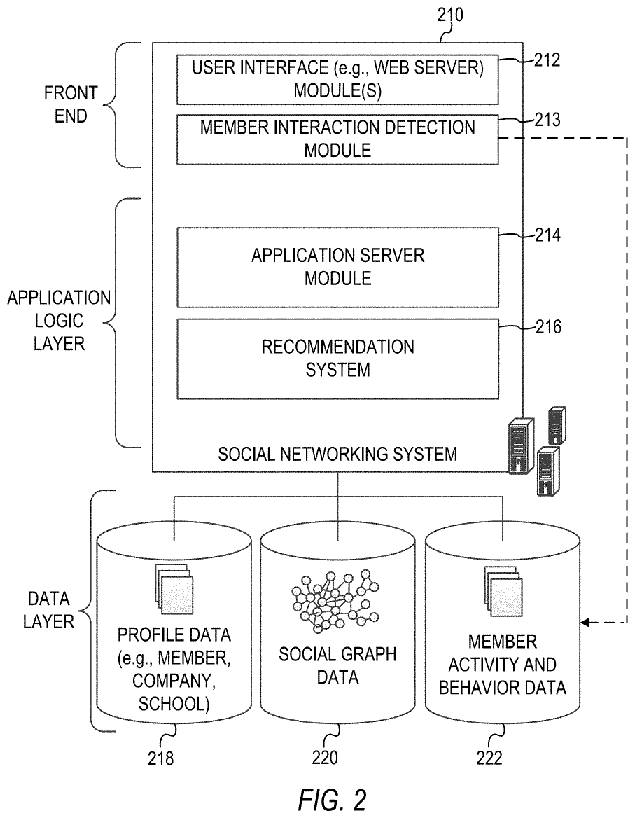

In some embodiments, the networked system 102 may comprise functional components of a social networking service. FIG. 2 is a block diagram showing the functional components of a social networking system 210, including a data processing module referred to herein as a recommendation system 216, for use in social networking system 210, consistent with some embodiments of the present disclosure. In some embodiments, the recommendation system 216 resides on application server(s) 118 in FIG. 1. However, it is contemplated that other configurations are also within the scope of the present disclosure.

As shown in FIG. 2, a front end may comprise a user interface module (e.g., a web server) 212, which receives requests from various client-computing devices, and communicates appropriate responses to the requesting client devices. For example, the user interface module(s) 212 may receive requests in the form of Hypertext Transfer Protocol (HTTP) requests, or other web-based, application programming interface (API) requests. In addition, a member interaction detection module 213 may be provided to detect various interactions that members have with different applications, services and content presented. As shown in FIG. 2, upon detecting a particular interaction, the member interaction detection module 213 logs the interaction, including the type of interaction and any meta-data relating to the interaction, in a member activity and behavior database 222.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service. In some example embodiments, the application logic layer includes the recommendation system 216.

As shown in FIG. 2, a data layer may include several databases, such as a database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 218. Similarly, when a representative of an organization initially registers the organization with the social networking service, the representative may be prompted to provide certain information about the organization. This information may be stored, for example, in the database 218, or another database (not shown). In some example embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources and made part of a company's profile.

Once registered, a member may invite other members, or be invited by other members, to connect via the social networking service. A “connection” may require or indicate a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph, shown in FIG. 2 with database 220.

As members interact with the various applications, services, and content made available via the social networking system 210, the members' interactions and behavior (e.g., content viewed, links or buttons selected, messages responded to, etc.) may be tracked and information concerning the member's activities and behavior may be logged or stored, for example, as indicated in FIG. 2 by the database 222. This logged activity information may then be used by the recommendation system 216. The members' interactions and behavior may also be tracked, stored, and used by the recommendation system 216 residing on a client device, such as within a browser of the client device, as will be discussed in further detail below.

In some embodiments, databases 218, 220, and 222 may be incorporated into database(s) 126 in FIG. 1. However, other configurations are also within the scope of the present disclosure.

Although not shown, in some embodiments, the social networking system 210 provides an application programming interface (API) module via which applications and services can access various data and services provided or maintained by the social networking service. For example, using an API, an application may be able to request and/or receive one or more navigation recommendations. Such applications may be browser-based applications or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third-party applications and services.

Although the recommendation system 216 is referred to herein as being used in the context of a social networking service, it is contemplated that it may also be employed in the context of any website or online services. Additionally, although features of the present disclosure can be used or presented in the context of a web page, it is contemplated that any user interface view (e.g., a user interface on a mobile device or on desktop software) is within the scope of the present disclosure.

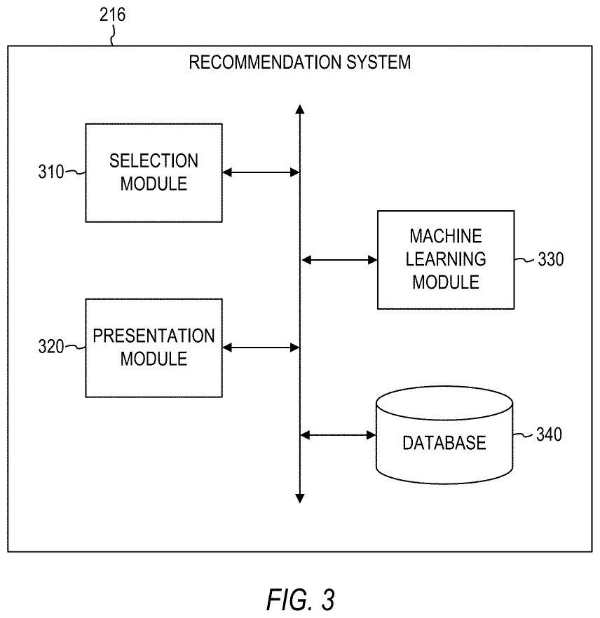

FIG. 3 is a block diagram illustrating components of a recommendation system 216, in accordance with an example embodiment. In some embodiments, the recommendation system 216 comprises any combination of one or more of a selection module 310, a presentation module 320, a machine learning module 330, and one or more database(s) 340. The selection module 310, the presentation module 320, the machine learning module 330, and the database(s) 340 can reside on a computer system, or other machine, having a memory and at least one processor (not shown). In some embodiments, the selection module 310, the presentation module 320, the machine learning module 330, and the database(s) 340 can be incorporated into the application server(s) 118 in FIG. 1. In some example embodiments, the database(s) 340 is incorporated into database(s) 126 in FIG. 1 and can include any combination of one or more of databases 218, 220, and 222 in FIG. 2. However, it is contemplated that other configurations of the selection module 310, the presentation module 320, the machine learning module 330, and the database(s) 340, are also within the scope of the present disclosure.

In some example embodiments, one or more of the selection module 310, the presentation module 320, and the machine learning module 330 is configured to provide a variety of user interface functionality, such as generating user interfaces, interactively presenting user interfaces to the user, receiving information from the user (e.g., interactions with user interfaces), and so on. Presenting information to the user can include causing presentation of information to the user (e.g., communicating information to a device with instructions to present the information to the user). Information may be presented using a variety of means including visually displaying information and using other device outputs (e.g., audio, tactile, and so forth). Similarly, information may be received via a variety of means including alphanumeric input or other device input (e.g., one or more touch screen, camera, tactile sensors, light sensors, infrared sensors, biometric sensors, microphone, gyroscope, accelerometer, other sensors, and so forth). In some example embodiments, one or more of the selection module 310, the presentation module 320, and the machine learning module 330 is configured to receive user input. For example, one or more of the selection module 310, the presentation module 320, and the machine learning module 330 can present one or more GUI elements (e.g., drop-down menu, selectable buttons, text field) with which a user can submit input.

In some example embodiments, one or more of the selection module 310, the presentation module 320, and the machine learning module 330 is configured to perform various communication functions to facilitate the functionality described herein, such as by communicating with the social networking system 210 via the network 104 using a wired or wireless connection. Any combination of one or more of the selection module 310, the presentation module 320, and the machine learning module 330 may also provide various web services or functions, such as retrieving information from the third party servers 130 and the social networking system 210. Information retrieved by the any of the selection module 310, the presentation module 320, and the machine learning module 330 may include profile data corresponding to users and members of the social networking service of the social networking system 210.

Additionally, any combination of one or more of the selection module 310, the presentation module 320, and the machine learning module 330 can provide various data functionality, such as exchanging information with database(s) 340 or servers. For example, any of the selection module 310, the presentation module 320, and the machine learning module 330 can access member profiles that include profile data from the database(s) 340, as well as extract attributes and/or characteristics from the profile data of member profiles. Furthermore, the one or more of the selection module 310, the presentation module 320, and the machine learning module 330 can access social graph data and member activity and behavior data from database(s) 340, as well as exchange information with third party servers 130, client machines 110, 112, and other sources of information.

In some example embodiments, the recommendation system 216 is configured to generate recommendations of destination users for which a source user should perform a particular source user action that is configured to prompt the destination users to perform a particular destination action. In certain examples discussed herein, the particular source user action comprises submitting an invitation to connect via a social networking service, and the particular destination user action comprises accepting an invitation to connect via the social networking service. However, other types of source user actions and other types of destination user actions are within the scope of the present disclosure. For example, in an alternative embodiment, the particular source user action comprises submitting an endorsement via a social networking service, and the particular destination user action comprises accepting an endorsement via a social networking service. For any discussion herein involving invitations to connect, alternative source user actions and destination user actions may be substituted in place of submitting an invitation to connect via a social networking service and accepting an invitation to connect via the social networking service.

In some example embodiments, the recommendation system 216 is configured to improve user recommendations by training personalized models on top of a global model. One potential problem of model personalization is the risk of aggravating user actions that negatively affect the functioning of the networked site on which they are performed. For example, if a user randomly sends invitations to connect, the personalized model will learn that behavior and recommend more random users. In another example, if a user targets all other users with a specific job title and company, the personalized model will help the user find more candidates to target. Therefore, personalizing the source side can improve the relevance and overall quality of the recommendations. However, personalizing at only the source side can potentially increase unhealthy connections by recommending more similar candidates to mass inviters.

In some example embodiments, the recommendation system 216 personalizes both the source side and the destination side. Modeling source users improves the quality of recommendations as the recommendation system 216 learns preferences of the user (e.g., user preferences for who to connect with) over time. Modeling destination users reduces the number of unhealthy recommendations at the source side, as destination model's score will also be used in ranking the candidate at the source side. As defined in network health strategy Two problems for network health are unwanted invitations and a diluted network. Personalizing the recommendation model at the source side helps prevent network dilution, as recommended candidates are personalized based on the source user's activity history. Personalizing the recommendation model at the destination side reduces the number of unwanted invitations, as the destination user model is also used for ranking the candidate.

In some example embodiments, the selection module 310 is configured to generate a corresponding score for each one of the plurality of destination user candidates based on a generalized linear mixed model comprising a global model and a destination user model. In some example embodiments, the global model is a generalized linear model based on feature data of a profile of a source user and feature data of a profile of the one of the plurality of destination user candidates. A generalized linear model is a flexible generalization of ordinary linear regression that allows for response variables that have error distribution models other than a normal distribution. The generalized linear model generalizes linear regression by allowing the linear model to be related to the response variable via a link function and by allowing the magnitude of the variance of each measurement to be a function of its predicted value.

In some example embodiments, the feature data discussed herein comprises at least one of educational background, company, industry, interests, and skills of a particular user. Other types of feature data are also within the scope of the present disclosure. The feature data may comprise any profile data stored in the database(s) 218 in FIG. 2, and the feature data may be retrieved from the database(s) 218 for use by the selection module 310 in generating the scores.

In some example embodiments, the destination user model is a random effects model based on behavior data of the destination user candidate for which the score is being generated. The behaviour data of the destination user candidate indicates whether the destination user candidate performed a particular destination user action in response to a particular source user action performed by reference source users that have been determined to have profiles with feature data similar to the feature data of the profile of the source user. In some example embodiments, the particular source user action is directed towards the destination user candidates, such as an invitation to connect being sent by the source user to the destination user.

In some example embodiments, the generalized linear mixed model further comprises a source user model. The source user model may be a random effects model that is based on behavior data of the source user indicating whether the source user performed the particular source user action directed towards a plurality of reference destination users that have been determined to have profiles with feature data similar to the feature data of the profile of the one of the plurality of destination user candidates. In some example embodiments, the source user model is further based on behavior data of the reference destination users indicating whether the reference destination users performed the particular destination user action in response to the particular source user action being performed by the source user.

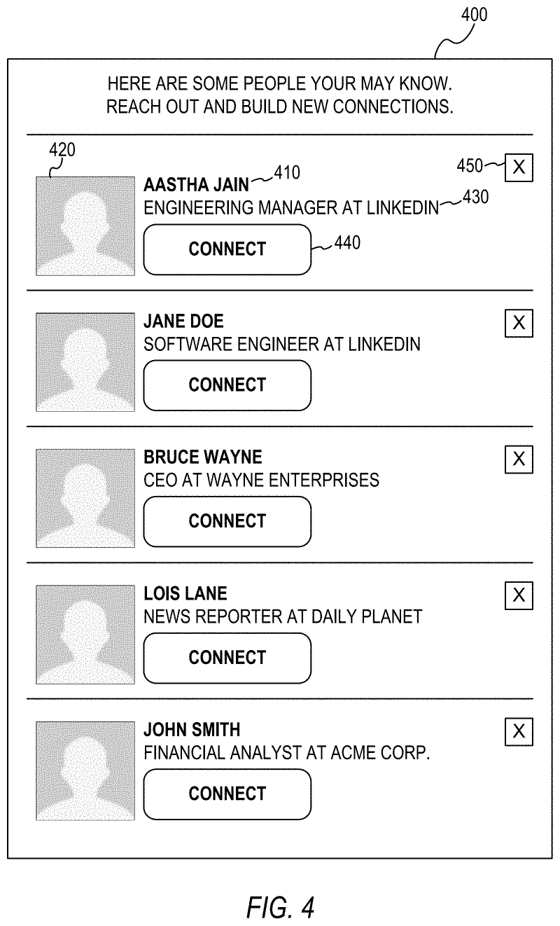

In some example embodiments, the particular source user action comprises submitting an invitation to connect via a social networking service, and the particular destination user action comprises accepting an invitation to connect via the social networking service. FIG. 4 illustrates a graphical user interface (GUI) in which recommendations for performing a particular source user action directed towards destination users are displayed to a source user, in accordance with an example embodiment. In the example shown in FIG. 4, the recommendations comprise recommendations of destination users for whom to send invitations to connect on a social networking service. In FIG. 4, the GUI 400 is presented to a source user and displays selectable options to send invitations to destination users of to become connections on the social networking service. Each selectable option may comprise an identification 410 of the destination user, an image 420 associated with a profile of the destination user, one or more attributes 430 of the destination user (e.g., job position, company), and a selectable user interface element 440 (e.g., a clickable button) configured to cause a user-to-user message (e.g., an invitation to connect) to be transmitted to the other user or to cause another type of source user action to be performed. Each selectable option may also comprise another selectable user interface element 450 configured to reject or otherwise dismiss the corresponding recommendation so as to indicate an instruction by the source user not to perform the source user action for the destination user of the corresponding recommendation.

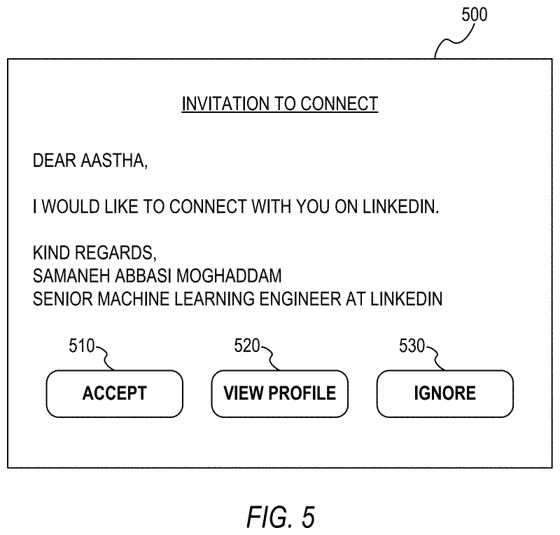

FIG. 5 illustrates a GUI 500 in which a selectable option to perform a particular destination user action is displayed to a destination user as a result of the source user performing the particular source user action, in accordance with an example embodiment. In FIG. 5, an invitation to connect with a source user on a social networking service is displayed to a destination user. As seen in FIG. 5, the invitation to connect may comprise an explanation that the destination user is being invited by a particular user to connect on the social networking service, along with a selectable user interface element 510 (e.g., an “ACCEPT” button) for accepting the invitation to connect, which is configured to cause the social networking service to generate and store a connection between the source user and the destination user in response to, or otherwise based on, the selection of the selectable user interface element 510. The invitation may also comprise a selectable user interface element 520 (e.g., a “VIEW PROFILE” button) configured to cause a profile of the source user who sent the invention to be displayed to the destination user in response to, or otherwise based on, its selection, as well as a selectable user interface element 530 (e.g., an “IGNORE” button) configured to decline or reject the invitation to connect in response to, or otherwise based on, its selection.

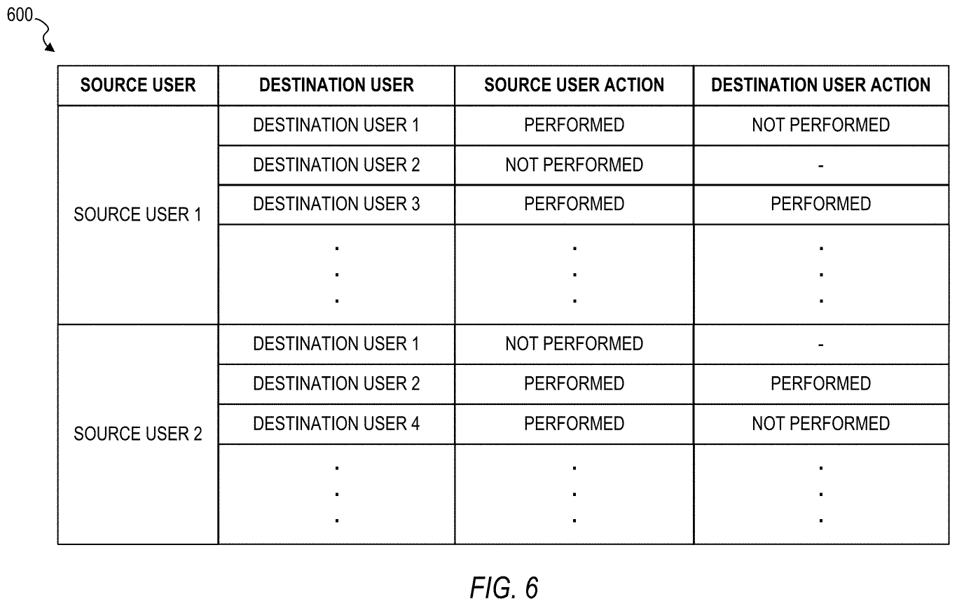

FIG. 6 illustrates a table 600 of behavior data for source users and for destination users, in accordance with an example embodiment. As seen in FIG. 6, the behaviour data indicates each instance in which a source user was presented with a recommendation to perform a source user action with respect to a particular destination user and whether or not the source user selected to perform the source user action for that particular destination user (e.g., “PERFORMED” or “NOT PERFORMED” in FIG. 6). The behaviour data also indicates, for each instance in which the source user selected to perform the source user action directed towards a particular destination user, whether or not the particular destination user selected to perform a particular destination user action in response to the source user action (e.g., “PERFORMED” or “NOT PERFORMED” in FIG. 6). In some example embodiments, the behaviour data is stored in and retrieved from the database(s) 222 in FIG. 2.

In some example embodiments, the selection module 310 is configured to select a subset of the plurality of destination user candidates from the plurality of destination user candidates based on the corresponding scores of the subset of the plurality of destination user candidates. The selection module 310 may select the subset of destination user candidates from the plurality of destination user candidates by ranking the plurality of destination user candidates based on their corresponding scores and then selecting the subset of destination user candidates based on the ranking of the plurality of destination user candidates, such as by selecting the top five ranked destination user candidates. However, other ways of selecting the subset of destination user candidates are also within the scope of the present disclosure.

In some example embodiments, the presentation module 320 is configured to cause a recommendation to be displayed on a computing device of the source user. The recommendation may comprise a recommendation to perform the particular source user action for the selected subset of destination user candidates. In some example embodiments, the recommendation comprises a corresponding selectable user interface element (e.g., a selectable button) configured to trigger the performance of the particular source user action for the corresponding destination user candidate in the subset in response to the corresponding selectable user interface element being selected by the source user. The recommendation may also comprises another corresponding selectable user interface element configured to trigger a rejection or dismissal of the recommendation of the particular source user action for the corresponding destination user candidate in response to being selected by the source user.

In some example embodiments, the machine learning module 330 is configured to access and retrieve the feature data and behaviour data of the source users and the destination users from the databases 218 and 222, and then use the retrieved feature data and behaviour data to train the source user model and the destination user model of the generalized linear mixed model via one or more machine learning operations.

Using the example use case involving recommendations for invitations to connect, in some example embodiments, the recommendation system 216 formulizes p(invite|impression), or pInvite, as a generalized linear mixed model with two random effects: source user model and destination user model. The generalized linear mixed model can predict the probability that source user s would connect to destination user d given an impression on a page of an online service, such as a page for a user's social network. Let y_{s,d,t} denote the binary response of whether source user s would send a connection invite to destination user d in the context t, where the context can include the time and location where the recommendation is shown. The generalized linear mixed model for predicting the probability of source member s sending connection invite to destination member d using logistic regression is:

g(E[y_{s,d,t}])=x′_{s,d,t}×b+p′_{d}×αₛ+q′ₛ×β_{d}

where g(.) is the link function, x′_{s,d,t} is the global feature vector for the (s, d, t) triple, p′_{d} is the destination member feature vector, q′ₛ is the source member feature vector, b is global coefficient vector, and αₛ and β_{d} are the coefficient vectors specific to source member s and destination member d, respectively. In some example embodiments, the generalized linear mixed model comprises three models: a fixed model that matches source and destination users based on the global features, a source user model that fits a better model to personalize recommendations over time as a source user invites/dismisses more user recommendations, and a destination user model that fits a better model to recommend a destination user to similar users of the current source users who sent an invitation to the destination user.

In some example embodiments, during an offline training of the model, a personalized model is trained for all source and destination users available in the data set. During online scoring, if personalized models are available for the users (source or destination), they are used for calculating the overall score. Otherwise candidates are ranked based on the global model score.

Some models may use cohort regression and be formulated as follows:

logit(Y_{N×1})≈X_{N×P}·β_{P×1}+U_{N×4S}·C_{4S×1}

where X and U are global and source member feature vectors respectively, β and C are fixed and random effect coefficients, respectively and S is dimensionality of random effects. In some example embodiments, the recommendation system 216 adds personalization on top of the above cohort model, formulating the model as:

g(E[y_{s,d,t}])=x′_{s,d,t}×b+q′ₛ×+cₛ+p′_{d}×+αₛ+q′ₛ×β_{d},

where cₛ is the cohort coefficient vector, q′ₛ and p′_{d} are source and destination member feature vectors, respectively. This provides the flexibility of personalizing recommendations at the cohort level. In some example embodiments, the above formula may also be generalized and defined as:

g(E[_{y,d,t}])=G(x′_{s,d,t},b)+p′_{d}×αₛ+q′ₛ×β_{d},

where G (x′_{s,d,t}, b) is be non-linear function. This provides the flexibility of utilizing a nonlinear model (e.g., a deep-n-wide model and deep-n-wide) as fixed effect model The above formula may also be generalized to incorporate a segmented regression model. To this end, the above equation may be reformulated as follows:

g(E[y_{d,t,s}])=x′_{s,d,t}×b+u′_{D}×eₛ+v′ₛ×z_{D}+p′_{d}×αₛ+q′ₛ×β_{d},

where u′_{D} and v′_{S} are destination-segment and source-segment features, respectively. e_{S} and z_{D} are segment-level random effect coefficients.

In some example embodiments, all connection requests are treated as positive signals, and any ignored/dismissed or stale recommendation (e.g., more than 28 days without sent invitation) are considered as negative signals (binary response) for the purposes of training the source user model and the destination user model.

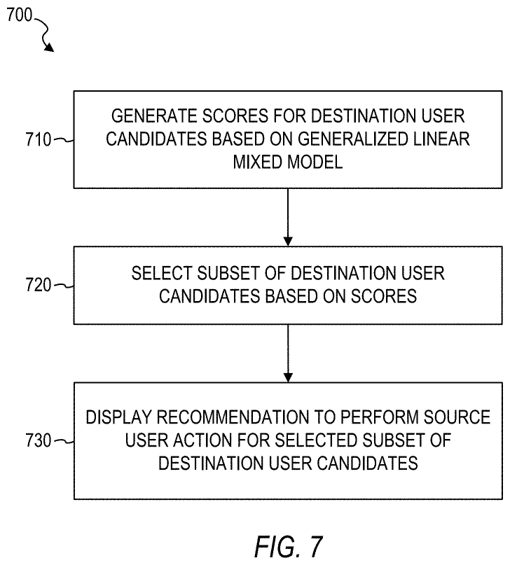

FIG. 7 is a flowchart illustrating a method 700 of generating recommendations using a generalized linear mixed model with destination user personalization, in accordance with an example embodiment. The method 700 can be performed by processing logic that can comprise hardware (e.g., circuitry, dedicated logic, programmable logic, microcode, etc.), software (e.g., instructions run on a processing device), or a combination thereof. In one implementation, the method 700 is performed by the recommendation system 216 of FIGS. 2-3, or any combination of one or more of its modules (e.g., the selection module 310, the presentation module 320, the machine learning module 330), as described above.

At operation 710, the recommendation system 216 generates a corresponding score for each one of the plurality of destination user candidates based on a generalized linear mixed model comprising a global model and a destination user model. In some example embodiments, the global model is a generalized linear model based on feature data of a profile of a source user and feature data of a profile of the one of the plurality of destination user candidates, and the destination user model is a random effects model based on behavior data of the one of the plurality of destination user candidates indicating whether the one of the plurality of destination user candidates performed a particular destination user action in response to a particular source user action performed by reference source users determined to have profiles with feature data similar to the feature data of the profile of the source user. In some example embodiments, the particular source user action is directed towards the one of the plurality of destination user candidates.

In some example embodiments, the generalized linear mixed model further comprises a source user model. The source user model may be a random effects model that is based on behavior data of the source user indicating whether the source user performed the particular source user action directed towards a plurality of reference destination users determined to have profiles with feature data similar to the feature data of the profile of the one of the plurality of destination user candidates. In some example embodiments, the source user model is further based on behavior data of the reference destination users indicating whether the reference destination users performed the particular destination user action in response to the particular source user action being performed by the source user.

In some example embodiments, the particular source user action comprises submitting an invitation to connect via a social networking service, and the particular destination user action comprises accepting an invitation to connect via the social networking service. In some example embodiments, the particular source user action comprises submitting an endorsement via a social networking service, and the particular destination user action comprises accepting an endorsement via a social networking service. Other types of source user actions and destination user actions are also within the scope of the present disclosure.

In some example embodiments, the feature data of the profile of the source user, the feature data of the profile of the destination user candidates, and the feature data of the reference source users comprise at least one of educational background, company, industry, interests, and skills. Other types of feature data are also within the scope of the present disclosure.

At operation 720, the recommendation system 216 selects a subset of the plurality of destination user candidates from the plurality of destination user candidates based on the corresponding scores of the subset of the plurality of destination user candidates. In some example embodiments, the selecting the subset of destination user candidates from the plurality of destination user candidates comprises ranking the plurality of destination user candidates based on their corresponding scores and selecting the subset of destination user candidates based on the ranking of the plurality of destination user candidates. For example the recommendation system 216 may select the top N ranked destination user candidates, where N is a positive integer (e.g., the top 5 ranked destination user candidates). However, other ways of selecting the subset of destination user candidates are also within the scope of the present disclosure.

At operation 730, the recommendation system 216 causes a recommendation to be displayed on a computing device of the source user. In some example embodiments, the recommendation comprises a recommendation to perform the particular source user action for the selected subset of destination user candidates. The recommendation may comprise a corresponding selectable user interface element (e.g., a selectable button) configured to trigger the performance of the particular source user action for the corresponding destination user candidate in the subset in response to the corresponding selectable user interface element being selected by the source user.

It is contemplated that any of the other features described within the present disclosure can be incorporated into the method 700.

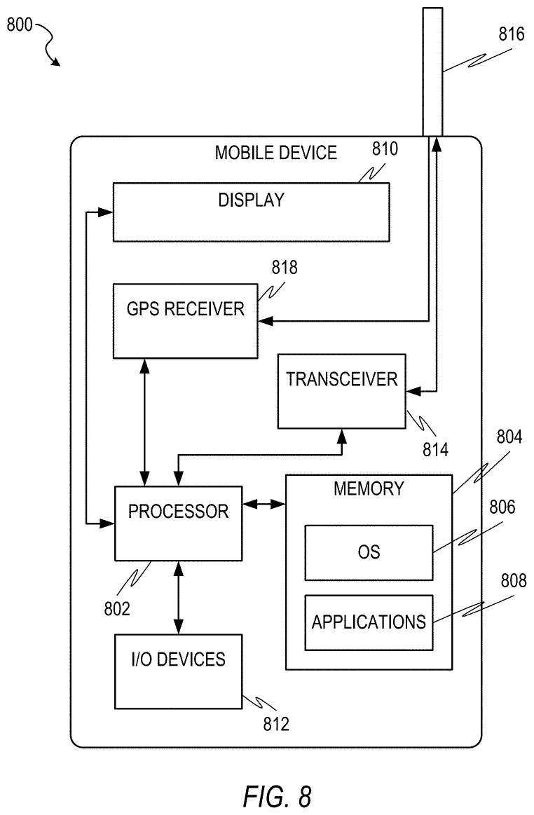

FIG. 8 is a block diagram illustrating a mobile device 800, according to an example embodiment. The mobile device 800 can include a processor 802. The processor 802 can be any of a variety of different types of commercially available processors suitable for mobile devices 800 (for example, an XScale architecture microprocessor, a Microprocessor without Interlocked Pipeline Stages (MIPS) architecture processor, or another type of processor). A memory 804, such as a random access memory (RAM), a Flash memory, or other type of memory, is typically accessible to the processor 802. The memory 804 can be adapted to store an operating system (OS) 806, as well as application programs 808, such as a mobile location-enabled application that can provide location-based services (LBSs) to a user. The processor 802 can be coupled, either directly or via appropriate intermediary hardware, to a display 810 and to one or more input/output (I/O) devices 812, such as a keypad, a touch panel sensor, a microphone, and the like. Similarly, in some embodiments, the processor 802 can be coupled to a transceiver 814 that interfaces with an antenna 816. The transceiver 814 can be configured to both transmit and receive cellular network signals, wireless data signals, or other types of signals via the antenna 816, depending on the nature of the mobile device 800. Further, in some configurations, a GPS receiver 818 can also make use of the antenna 816 to receive GPS signals.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a processor configured using software, the processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

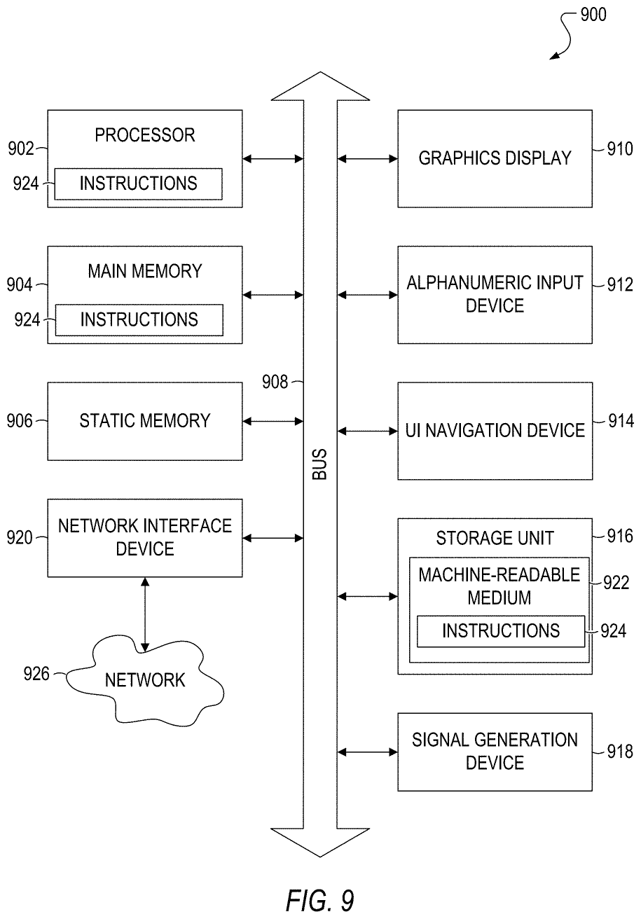

FIG. 9 is a block diagram of an example computer system 900 on which methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a graphics display unit 910 (e.g., a liquid crystal display (LCD) or a cathode ray tube (CRT)). The computer system 900 also includes an alphanumeric input device 912 (e.g., a keyboard or a touch-sensitive display screen), a user interface (UI) navigation device 914 (e.g., a mouse), a storage unit 916, a signal generation device 918 (e.g., a speaker) and a network interface device 920.

The storage unit 916 includes a machine-readable medium 922 on which is stored one or more sets of instructions and data structures (e.g., software) 924 embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions 924 or data structures. The term “machine-readable medium” shall also be taken to include any tangible medium that is capable of storing, encoding or carrying instructions (e.g., instructions 924) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

The following numbered examples are embodiments.
1. A computer-implemented method comprising:
   for each one of the plurality of destination user candidates, generating, by a computer system having a memory and at least one hardware processor, a corresponding score based on a generalized linear mixed model comprising a global model and a destination user model, the global model being a generalized linear model based on feature data of a profile of a source user and feature data of a profile of the one of the plurality of destination user candidates, and the destination user model being a random effects model based on behavior data of the one of the plurality of destination user candidates indicating whether the one of the plurality of destination user candidates performed a particular destination user action in response to a particular source user action performed by reference source users determined to have profiles with feature data similar to the feature data of the profile of the source user, the particular source user action being directed towards the one of the plurality of destination user candidates;
   selecting, by the computer system, a subset of the plurality of destination user candidates from the plurality of destination user candidates based on the corresponding scores of the subset of the plurality of destination user candidates; and
   causing, by the computer system, a recommendation to be displayed on a computing device of the source user, the recommendation comprising a recommendation to perform the particular source user action for the selected subset of destination user candidates.
2. The computer-implemented method of example 1, wherein the generalized linear mixed model further comprises a source user model, the source user model being a random effects model based on behavior data of the source user indicating whether the source user performed the particular source user action directed towards a plurality of reference destination users determined to have profiles with feature data similar to the feature data of the profile of the one of the plurality of destination user candidates.
3. The computer-implemented method of example 2, wherein the source user model is further based on behavior data of the reference destination users indicating whether the reference destination users performed the particular destination user action in response to the particular source user action being performed by the source user.
4. The computer-implemented method of any one of examples 1 to 3, wherein the particular source user action comprises submitting an invitation to connect via a social networking service, and the particular destination user action comprises accepting an invitation to connect via the social networking service.
5. The computer-implemented method of any one of examples 1 to 4, wherein the particular source user action comprises submitting an endorsement via a social networking service, and the particular destination user action comprises accepting an endorsement via a social networking service.
6. The computer-implemented method of any one of examples 1 to 5, wherein the feature data of the profile of the source user, the feature data of the profile of the destination user candidates, and the feature data of the reference source users comprise at least one of educational background, company, industry, interests, and skills.
7. The computer-implemented method of any one of examples 1 to 6, wherein the selecting the subset of destination user candidates from the plurality of destination user candidates comprises:
   ranking the plurality of destination user candidates based on their corresponding scores; and
   selecting the subset of destination user candidates based on the ranking of the plurality of destination user candidates.
8. A system comprising:
   at least one processor; and
   a non-transitory computer-readable medium storing executable instructions that, when executed, cause the at least one processor to perform the method of any one of examples 1 to 7.
9. A non-transitory machine-readable storage medium, tangibly embodying a set of instructions that, when executed by at least one processor, causes the at least one processor to perform the method of any one of examples 1 to 7.
10. A machine-readable medium carrying a set of instructions that, when executed by at least one processor, causes the at least one processor to carry out the method of any one of examples 1 to 7.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
for each one of the plurality of destination user candidates, generating, by a computer system having a memory and at least one hardware processor, a corresponding score based on a generalized linear mixed model comprising a global model and a destination user model, the global model being a generalized linear model based on feature data of a profile of a source user and feature data of a profile of the one of the plurality of destination user candidates, and the destination user model being a random effects model based on behavior data of the one of the plurality of destination user candidates indicating whether the one of the plurality of destination user candidates performed a particular destination user action in response to a particular source user action performed by reference source users determined to have profiles with feature data similar to the feature data of the profile of the source user, the particular source user action being directed towards the one of the plurality of destination user candidates;
selecting, by the computer system, a subset of the plurality of destination user candidates from the plurality of destination user candidates based on the corresponding scores of the subset of the plurality of destination user candidates; and
causing, by the computer system, a recommendation to be displayed on a computing device of the source user, the recommendation comprising a recommendation to perform the particular source user action for the selected subset of destination user candidates.

2. The computer-implemented method of claim 1, wherein the generalized linear mixed model further comprises a source user model, the source user model being a random effects model based on behavior data of the source user indicating whether the source user performed the particular source user action directed towards a plurality of reference destination users determined to have profiles with feature data similar to the feature data of the profile of the one of the plurality of destination user candidates.

3. The computer-implemented method of claim 2, wherein the source user model is further based on behavior data of the reference destination users indicating whether the reference destination users performed the particular destination user action in response to the particular source user action being performed by the source user.

4. The computer-implemented method of claim 1, wherein the particular source user action comprises submitting an invitation to connect via a social networking service, and the particular destination user action comprises accepting an invitation to connect via the social networking service.

5. The computer-implemented method of claim 1, wherein the particular source user action comprises submitting an endorsement via a social networking service, and the particular destination user action comprises accepting an endorsement via a social networking service.

6. The computer-implemented method of claim 1, wherein the feature data of the profile of the source user, the feature data of the profile of the destination user candidates, and the feature data of the reference source users comprise at least one of educational background, company, industry, interests, and skills.

7. The computer-implemented method of claim 1, wherein the selecting the subset of destination user candidates from the plurality of destination user candidates comprises:
ranking the plurality of destination user candidates based on their corresponding scores; and
selecting the subset of destination user candidates based on the ranking of the plurality of destination user candidates.

8. A system comprising:
at least one hardware processor; and
a non-transitory machine-readable medium embodying a set of instructions that, when executed by the at least one hardware processor, cause the at least one processor to perform operations, the operations comprising:
for each one of the plurality of destination user candidates, generating a corresponding score based on a generalized linear mixed model comprising a global model and a destination user model, the global model being a generalized linear model based on feature data of a profile of a source user and feature data of a profile of the one of the plurality of destination user candidates, and the destination user model being a random effects model based on behavior data of the one of the plurality of destination user candidates indicating whether the one of the plurality of destination user candidates performed a particular destination user action in response to a particular source user action performed by reference source users determined to have profiles with feature data similar to the feature data of the profile of the source user, the particular source user action being directed towards the one of the plurality of destination user candidates;
selecting a subset of the plurality of destination user candidates from the plurality of destination user candidates based on the corresponding scores of the subset of the plurality of destination user candidates; and
causing a recommendation to be displayed on a computing device of the source user, the recommendation comprising a recommendation to perform the particular source user action for the selected subset of destination user candidates.

9. The system of claim 8, wherein the generalized linear mixed model further comprises a source user model, the source user model being a random effects model based on behavior data of the source user indicating whether the source user performed the particular source user action directed towards a plurality of reference destination users determined to have profiles with feature data similar to the feature data of the profile of the one of the plurality of destination user candidates.

10. The system of claim 9, wherein the source user model is further based on behavior data of the reference destination users indicating whether the reference destination users performed the particular destination user action in response to the particular source user action being performed by the source user.

11. The system of claim 8, wherein the particular source user action comprises submitting an invitation to connect via a social networking service, and the particular destination user action comprises accepting an invitation to connect via the social networking service.

12. The system of claim 8, wherein the particular source user action comprises submitting an endorsement via a social networking service, and the particular destination user action comprises accepting an endorsement via a social networking service.

13. The system of claim 8, wherein the feature data of the profile of the source user, the feature data of the profile of the destination user candidates, and the feature data of the reference source users comprise at least one of educational background, company, industry, interests, and skills.

14. The system of claim 8, wherein the selecting the subset of destination user candidates from the plurality of destination user candidates comprises:
ranking the plurality of destination user candidates based on their corresponding scores; and
selecting the subset of destination user candidates based on the ranking of the plurality of destination user candidates.

15. A non-transitory machine-readable medium embodying a set of instructions that, when executed by at least one hardware processor, cause the processor to perform operations, the operations comprising:
for each one of the plurality of destination user candidates, generating a corresponding score based on a generalized linear mixed model comprising a global model and a destination user model, the global model being a generalized linear model based on feature data of a profile of a source user and feature data of a profile of the one of the plurality of destination user candidates, and the destination user model being a random effects model based on behavior data of the one of the plurality of destination user candidates indicating whether the one of the plurality of destination user candidates performed a particular destination user action in response to a particular source user action performed by reference source users determined to have profiles with feature data similar to the feature data of the profile of the source user, the particular source user action being directed towards the one of the plurality of destination user candidates;
selecting a subset of the plurality of destination user candidates from the plurality of destination user candidates based on the corresponding scores of the subset of the plurality of destination user candidates; and
causing a recommendation to be displayed on a computing device of the source user, the recommendation comprising a recommendation to perform the particular source user action for the selected subset of destination user candidates.

16. The non-transitory machine-readable medium of claim 15, wherein the generalized linear mixed model further comprises a source user model, the source user model being a random effects model based on behavior data of the source user indicating whether the source user performed the particular source user action directed towards a plurality of reference destination users determined to have profiles with feature data similar to the feature data of the profile of the one of the plurality of destination user candidates.

17. The non-transitory machine-readable medium of claim 16, wherein the source user model is further based on behavior data of the reference destination users indicating whether the reference destination users performed the particular destination user action in response to the particular source user action being performed by the source user.

18. The non-transitory machine-readable medium of claim 15, wherein the particular source user action comprises submitting an invitation to connect via a social networking service, and the particular destination user action comprises accepting an invitation to connect via the social networking service.

19. The non-transitory machine-readable medium of claim 15, wherein the particular source user action comprises submitting an endorsement via a social networking service, and the particular destination user action comprises accepting an endorsement via a social networking service.

20. The non-transitory machine-readable medium of claim 15, wherein the feature data of the profile of the source user, the feature data of the profile of the destination user candidates, and the feature data of the reference source users comprise at least one of educational background, company, industry, interests, and skills.
